(19) United States
(12) Patent Application Publication
(10) Pub. No.: US 2026/0102982 A1
(43) Pub. Date: Apr. 16, 2026

(54) Mold-Based Diffractive Optics

(71) Applicant: UNITED STATES OF AMERICA AS REPRESENTED BY THE ADMINISTRATOR OF NASA, Washington, DC (US)

(72) Inventors: John P. Leckey, Poquoson, VA (US); Vinh Nquyen, Blacksburg, VA (US); Leslie Howe, Blacksburg, VA (US); Tharindu Rajapaksha, Blacksburg, VA (US); Scott M. Bartram, Yorktown, VA (US); David G. MacDonnell, Yorktown, VA (US)

(21) Appl. No.: 19/240,569

(22) Filed: Jun. 17, 2025

Related U.S. Application Data
(60) Provisional application No. 63/664,750, filed on Jun. 27, 2024.

(51) Int. Cl. B29D 11/00; B29C 33/02; B29C 33/38; B29C 33/42

(52) U.S. Cl. CPC B29D 11/00769; B29C 33/02; B29C 33/3842; B29C 33/42

(57) ABSTRACT

A membrane may be fabricated utilizing a mold, wherein the mold comprises individual mold sections. The membrane may comprise a diffractive optical element (DOE) having diffractive surface features that are formed by mod surfaces of the mold. The membrane (DOE) may be flexible, whereby the membrane can be stowed in a compact configuration and deployed when the DOE is in a use location.

### CROSS-REFERENCE TO RELATED PATENT APPLICATION(S)

This patent application claims the benefit of and priority to Provisional Application No. 63/664,750, filed on Jun. 27, 2024, the contents of which are hereby incorporated by reference in their entirety.

### STATEMENT REGARDING FEDERALLY SPONSORED RESEARCH OR DEVELOPMENT

The invention described herein was made in the performance of work under a NASA contract and by employees of the United States Government and is subject to the provisions of Public Law 96-517 (35 U.S. C. § 202) and may be manufactured and used by or for the Government for governmental purposes without the payment of any royalties thereon or therefore. In accordance with 35 U.S. C. § 202, the contractor elected not to retain title.

### BACKGROUND OF THE INVENTION

Various types of diffractive optical elements (DOEs) have been developed. Examples include Fresnel Zone Plates (FZPs) and Photon Sieves (PSs).

In general, optics may comprise rigid substrates such as fused silica, quartz, or silicon plates. Micro-patterns may be fabricated by ultraviolet (UV) or electron beam lithography. The micro-patterns may be utilized to form membrane-based flexible diffractive optics devices. Laser ablation is known approach process that may be utilized to fabricate micro-patterning on a flexible membrane. The desired features (size and depth) may be formed by controlling laser power and scanning speed. Ablation can occur under continuous wave (CW) or pulsed laser illumination when the incident optical energy is above the “threshold fluence” or “threshold energy density” of a material. The specific ablation threshold for a given material will depend on the material absorption behavior, thermal conductivity, the presence of defects, microstructures, etc., and the incident laser processing parameters. The laser processing parameters may include pulse width, peak power, laser beam profile, and wavelength. Thus, known ablation processes may be limited to a specific polymer which is optimum for a specific laser.

### BRIEF SUMMARY OF THE INVENTION

An aspect of the present disclosure is a method of forming a membrane such as diffractive optical element (DOE) 10 that diffracts light that passes through the DOE. The method includes forming a plurality of mold segments that can be closely positioned adjacent one another along edges of the adjacent mold segments. The method includes affixing the mold segments to a backing substrate adjacent one another to form a mold having a substantially continuous a three-dimensional (3D) surface comprising an inverse of a 3D surface of a DOE to be formed by the mold segments. The method further includes depositing uncured polymer material on the 3D mold surface. The polymer material is cured to form a substantially continuous one-piece DOE having diffractive surface elements on at least one side thereof. The DOE is then removed from the mold.

The method may include determining a diffraction pattern of a one-piece DOE to be formed, wherein the diffraction pattern is based, at least in part, on: 1) a wavelength of light that will pass through the one-piece DOE in use, and/or: 2) a focal length of the one-piece DOE, and/or: 3) a size of the one-piece DOE, and/or: 4) a refractive index of the cured polymer material of the one-piece DOE, and/or: 5) a focusing efficiency of the one-piece DOE.

Each mold segment may define a perimeter, and the shapes and sizes of the perimeters of the mold segments may be identical.

The perimeters of the mold segments may be hexagonal, and the backing substrate may be flat.

The mold segments may be formed from a rigid material utilizing photolithography and etching.

The mold segments may be fixed to the backing substrate to form a pattern about a central portion of the mold surface.

The pattern formed by the mold segments may be radially symmetric about the central portion of the mold surface.

The mold segments may include 3D mold surfaces corresponding to diffractive features of the one-piece DOE. A 3D mold surface of a mold segment at the central portion of the mold surface may include features of a first size, and a 3D mold surface of at least one mold segment outside of the central portion of the mold surface may include features of a second size that are smaller than the first size, whereby at least one diffractive feature at a central portion of the one-piece DOE has a size that is greater than a size of at least one diffractive feature formed by the at least one mold segment outside of the central portion of the mold surface.

The 3D mold surface may include at least some indentations that are formed by a multi-step photolithography and etching process, whereby additional material is removed during successive steps to form deeper portions in indentations formed during prior photolithography and etching steps, and wherein a horizontal dimension of material removed during successive steps may be reduced relative to a horizontal dimension of material removed during prior steps.

The diffractive surface elements may form: 1) a Fresnel Zone Plate or: 2) a photon sieve.

The uncured polymer material may comprise polyamide powder that is dissolved in a solvent, and the mold segments may comprise silicon wafers having polished first and second opposite side surfaces. The method may include forming 3D mold features corresponding to the diffractive surface elements in the first side surfaces of the silicon wafers using a multi-step chemical etching process. After depositing uncured polymer material on the 3D mold surface, the mold and uncured polymer material may be positioned in a vacuum to remove air bubbles from the uncured polymer material. The method may include heating the mold and uncured polymer while the uncured polymer is positioned in a vacuum to remove solvent from the uncured polymer.

The mold segments may form at least four concentric rings about a central mold segment.

Another aspect of the present invention is a method of forming a flexible membrane. The method includes forming a plurality of mold segments, each having a mold surface, a back surface, and a perimeter, where in the perimeters of the mold segments have substantially identical shapes and sizes. The method further includes affixing the mold segments to a backing substrate adjacent to one another in rings about a center mold segment to form a mold having a substantially continuous mold surface. Uncured polymer material is deposited on the mold surface, and the polymer material is cured to form a substantially continuous one-piece flexible membrane. The flexible membrane is then removed from the mold surface.

The perimeters of the mold segments may be hexagonal.

The mold segments may comprise a rigid material, and the mold surface may be formed utilizing photolithography and etching.

The flexible membrane may comprise a diffractive optical element (DOE) having three-dimensional (3D) refractive surface features. The mold segments may include 3D mold surfaces corresponding to diffractive features of the DOE.

The uncured polymer material may comprise polyimide powder that is dissolved in solvent, and the mold segments may comprise silicon wafers having first and second opposite side surfaces. The method may include forming 3D mold features corresponding to the diffractive surface elements in the first side surfaces of the silicon wafers using a multi-step chemical etching process. After the uncured polymer material is deposited on the 3D mold surface, the mold and uncured polymer material may be positioned in a vacuum to remove air bubbles from the uncured polymer material. The method may include heating the mold and uncured polymer material while the uncured polymer is positioned in a vacuum to thereby remove solvent from the uncured polymer.

Another aspect of the present disclosure is a method of making a mold. The method includes forming a plurality of mold segments, each having a perimeter and a mold surface comprising three-dimensional (3D) mold surface features comprising in invers of a 3D surface of a diffractive optical element (DOE) to be formed. The perimeters of the mold segments may be substantially identical to one another. The method includes affixing the mold segments to a backing substrate adjacent to one another in concentric rings about a center mold segment to form a mold having a substantially continuous 3D mold surface.

The mold segments may optionally comprise a rigid material, and the 3D mold surface features may be formed utilizing photolithography and etching.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a partially schematic isometric view of a process for forming a diffractive optic via a mold;

FIG. 2 is a schematic showing diffractive optics according to an aspect of the present disclosure;

FIG. 3 is a cross-sectional isometric view of a DOE according to an aspect of the present disclosure;

FIG. 4 is a schematic of a DOE;

FIG. 5 is a schematic showing DOEs according to an aspect of the present disclosure;

FIG. 6 is an isometric schematic showing steps of making a mold according to an aspect of the present disclosure;

FIG. 7 is a plan view of a mold formed from individual mold segments;

FIG. 8 is a schematic of a process of making a mold according to an aspect of the present disclosure;

FIG. 9 is a partially fragmentary isometric view showing assembly of mold segments on a vacuum table;

FIG. 10 is a partially fragmentary isometric view showing assembly of mold segments on a vacuum table;

FIG. 11 is a partially fragmentary isometric view showing assembly of mold segments on a vacuum table;

FIG. 12 is a partially fragmentary isometric view showing assembly of mold segments on a vacuum table;

FIG. 13 is a partially fragmentary isometric view showing assembly of mold segments on a vacuum table;

FIG. 14 is a partially fragmentary isometric view showing UV light being applied from below to cure adhesive;

FIG. 15 is an isometric view of a mold according to an aspect of the present disclosure; and

FIG. 16 is a schematic showing casting of a DOE according to an aspect of the present disclosure.

### DETAILED DESCRIPTION OF THE INVENTION

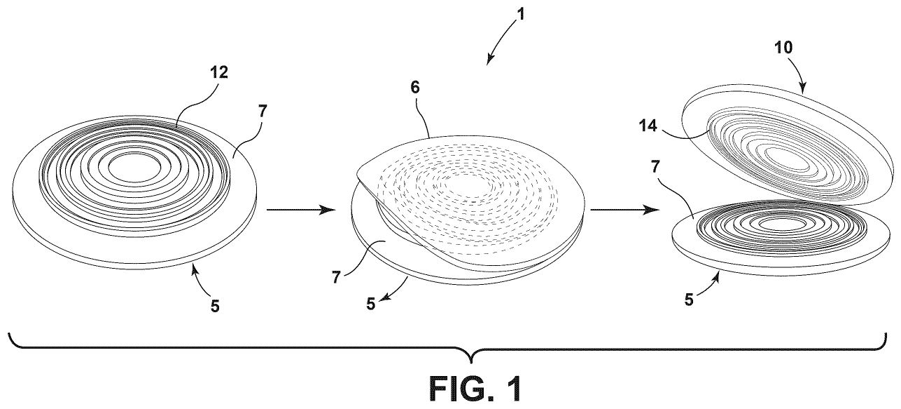

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a method 1 for forming a diffractive optical element (DOE) includes forming a mold 5, positioning an uncured polymer material 6 on a surface 7 of the mold 5 allowing the polymer material 6 to cure to form a DOE 10, followed by removing the DOE 10. As discussed in more detail below, upper surface 7 of mold 5 may include a plurality of three dimensional (3D) mold surface features 12 that are inverses of 3D diffractive surface elements 14 of DOE 10.

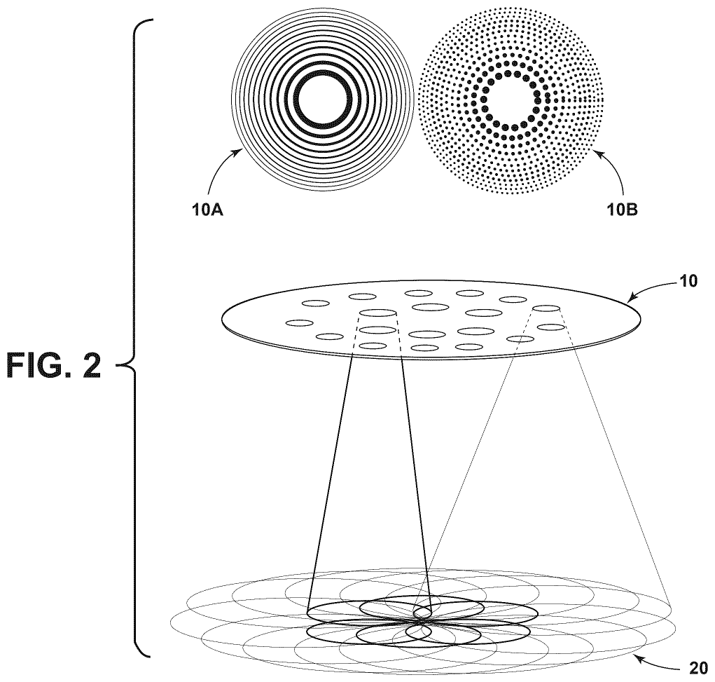

With further reference to FIG. 2, DOE 10 may comprise a Fresnel Zone Plate 10A or a photon sieve 10B that are configured to form a desired light pattern 20. In general, the DOE 10 may comprise a telescope that is configured to create a magnified light pattern 20 when incident light having a single wavelength is incident on the DOE 10 (e.g. in a LIDAR system). DOE 10 may comprise a thin flexible membrane that is held in tension in a substantially flat configuration on a frame or other suitable structure when DOE 10 is in use. The frame may be deployably mounted to a spacecraft structure and may extend from a stowed (launch) position to a deployed position when the DOE 10 and spacecraft structure are on station (e.g. outside the Earth's atmosphere).

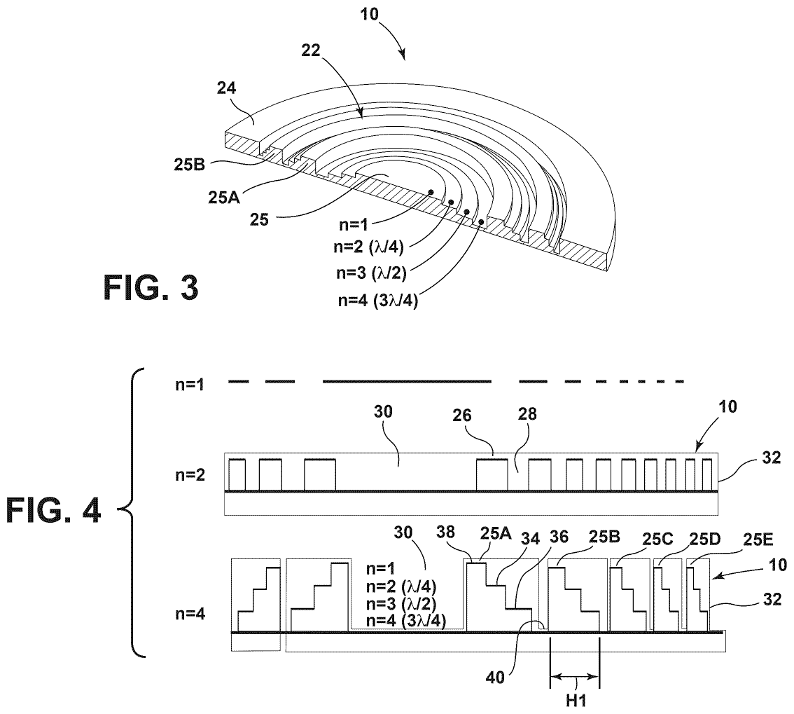

With further reference to FIGS. 3 and 4, DOE 10 may include a plurality of 3D diffractive elements 22 on a surface 24 of the DOE 10. The diffractive elements may comprise a center element 25 and a plurality of rings 25A, 25B, etc. that extend around the center 25. The rings may optionally have a rectangular cross-sectional shape 26 (FIG. 4) with grooves 28 extending between adjacent rings 26. In general, the features of the rings may be larger adjacent a central portion 30 of the DOE, and smaller adjacent a perimeter 32 of the DOE to provide increased efficiency. Also, steps 34 and 36 may be formed in rings 26 and grooves 28 to provide improved efficiency. An overall width H1 of the rings 26 may be reduced adjacent perimeter 32 relative to central portion 30, and a horizontal dimension of steps 34 and 36, and upper surface 38 of the rings 26 may also be reduced adjacent perimeter 32 relative to central portion 30 of DOE 10. As discussed in more detail below, the mold 5 (FIG. 1) may be formed in a multi-step photolithography process whereby the 3D mold surface features 12 of the mold are formed by removing material in steps. Thus, an upper surface 38 of DOE 10 may be formed utilizing a first photolithography step (n32 1), and additional material may be removed utilizing additional photolithography steps (n=2, n=3, n=4, etc.) to form additional steps 34, 36, and surface 40 between adjacent rings 26. As shown in FIGS. 3 and 4, the steps may correspond to wavelengths λ/4, λ/2, 3 λ/4, etc.

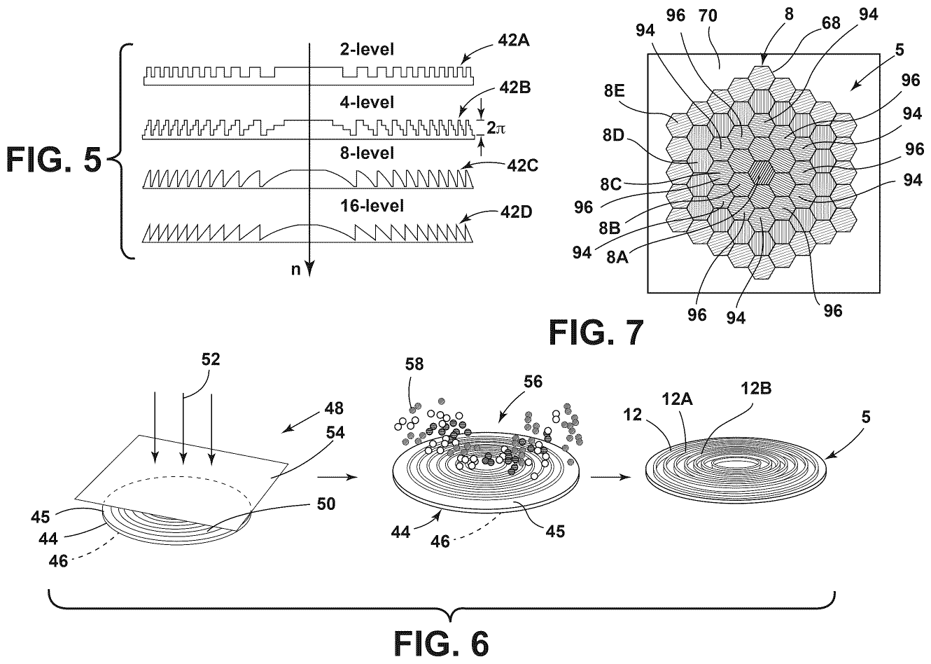

With further reference to FIG. 5, a phase-type Freznel Zone Plate (FZP) may comprise a 2-level FZP 42A, a 4-level FZP 42B, an 8-level FZP 42C, or a 16-level FZP 42D. In general, the increasing levels (resulting from increased numbers of material removal steps during the photolithography process) provide more accurate 3D diffractive elements, whereby a greater number of levels provides a device having increased efficiency.

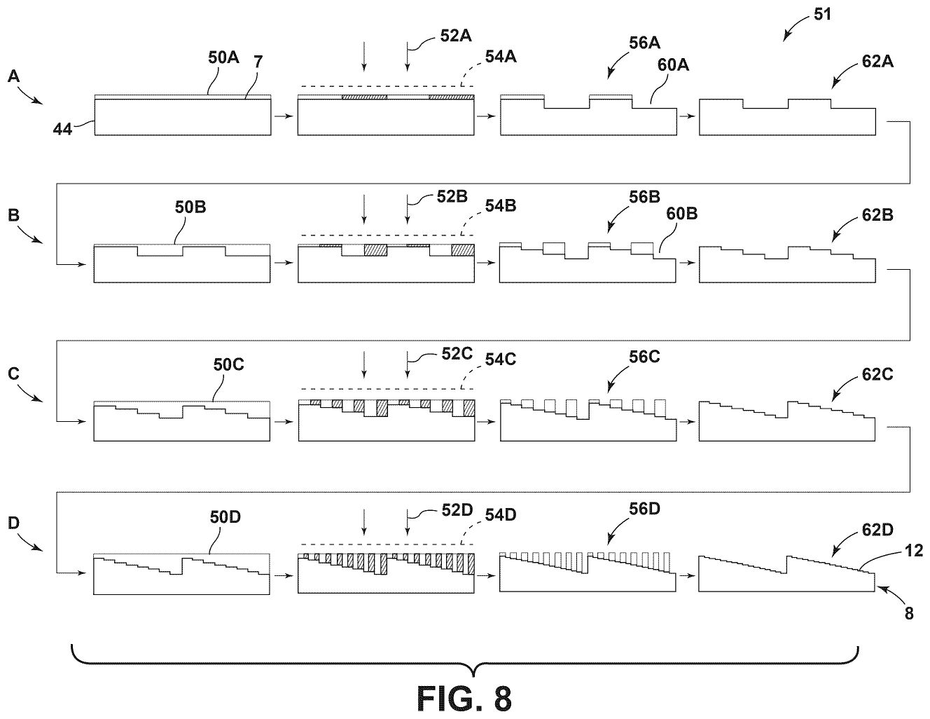

With further reference to FIG. 6, mold 5 may be formed from a suitable substrate such as a silicon wafer 44 having upper and lower surfaces 45 and 46, respectively silicon wafer 44 may comprise a plurality of individual wafers that form mold segments 8 (FIG. 7) that are fixed to a substrate 70 to form mold 5. As discussed in more detail below in connection with FIG. 8, during photolithography process 48, a photoresist material 50 is deposited on a face or upper surface 45 silicon wafer 45, and UV light 52 is selectively applied to the photoresist 50 through a mask 54. Reactive ion etching 56 is then utilized to selectively remove material 58 from upper surface 45 of silicon wafer 44 to form 3D mold surface features 12. The 3D mold surface features 12 may comprise inverse features corresponding to the rings 26 and grooves 28 of DOE 10. For example, the mold surface features 12 may comprise a plurality of concentric raised rings 12A corresponding to grooves 28 of DOE 10, and a plurality of grooves 12B corresponding to rings 26 of DOE 10. It will be understood that the size of the surface features 12 is exaggerated in FIG. 6.

With further reference to FIG. 7, mold 5 may comprise a plurality of mold sections 8 each having hexagonal perimeters 68, whereby the mold sections 8 can be fitted closely together about a center mold section 8A to form rings 8B-8E about center mold sections 8A. As discussed in more detail below in connection to FIG. 14, the mold sections 8 may be bonded to a substrate 70. As also discussed below, the 3D mold surface features of the individual mold sections 8 may have a larger number of levels adjacent the center mold section 8A, and the sizes of the 3D mold surface features may decrease in the rings 8B-8E to provide diffractive elements in DOE 10 having layer sizes at a central portion of DOE 10 and reduced size adjacent peripheral portions of DOE 10.

With further reference to FIG. 7, individual mold sections 8 may comprise hexagon plates that are positioned adjacent one another on a substrate 70 to form a mold 5. Mold 5 may be configured to mold a DOE 10 comprising a Multilevel Freznel Zone Plate (MLFZP). The mold segments 8 may be fabricated from silicon wafers 44 using silicon mold photolithography and polyamide membrane casting processes as shown in FIG. 6.

With further reference to FIG. 8, a process 51 for forming a mold segments 8 having a mold surface 12 may include a plurality of rows A-D forming levels in upper surface 7 of a silicon wafer 44. At a start of process 51 a layer of hexamethyldisilane (HMDS) (not shown) may be formed on upper surface 45 of wafer 44, and a photoresist layer 50A may then be formed utilizing spin coating or other suitable process. UV light 52A may then be selectively applied utilizing mask 54A, followed by reactive ion etching 56A to remove material and form recesses 60A, followed by removal of photoresist 50 as shown at 62A. After the photoresist is removed at 62A, process 51 may proceed at row B, and the steps of row A can be repeated specifically, photoresist 50B can be applied, followed by exposure UV light 52B, followed reactive ion etching 56B, and photoresist removal 62B. The process of rows A and B can be repeated as shown by rows C and D. In general, the steps of first row A produce a 2-level DOE, second row B forms a 4-level DOE, third row C produces an 8-level DOE, and fourth row D produces a 16-level DOE. In general, the mold fabrication process of FIG. 8 may include as many rows as desired to produce the desired number of steps in a given mold section 8.

As noted above, HMDS may be bonded to upper surface 45 of wafer 44. The HMDS may be bonded utilizing spin coating, and the HMDS may be bonded by heating at, for example, 110° C. for 4 minutes. The heating causes the HMDS to chemically bond to an oxidized surface to allow for the photoresist 50 to adhere. Photoresist 50 may be selected to provide an optimal high resolution and high thermal stability for chemical etching. The photoresist 50 may be deposited in a thickness of about 1 micrometer, and the photoresist 50 may be heated at, for example, 90° C. for 1 minute, to provide sufficient resolution. For example, the feature resolution from the photoresist 50 may be approximately 0.6 [symbol] m. Following the deposition of the photoresist 50 by spin coating, the wafers 44 may be exposed to UV light 52. According to an example, the UV light was provided by a Karl Suss MA6 with an i-line and a dosage of 24-30 mJ/cm², depending on the minimum desired feature size. For larger features, a higher dosage of UV light allows for more distinct edges on the pattern, while a smaller dose ensures correct resolution for small features. The alignment may be done using multiple markers along the edges of the features to allow for high precision, along with a hard contact exposure and minimum allowable alignment gap between the mask 54 and substrate to fabricate the mold sections 8 (if the mold sections 8 are fabricated from silicon).

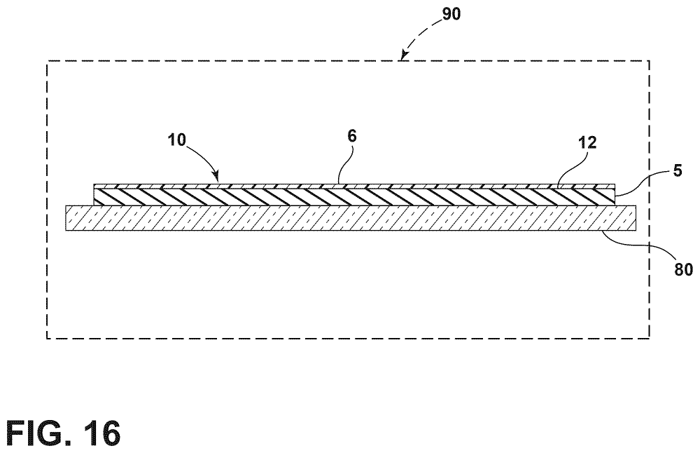

Referring again to FIG. 8, the first photomask (row A) shapes 2-level zones, and each consecutive mask (rows B-D) divides the zones in half for further levels, until the desired 3D mold surface structures are achieved. In the example of FIGS. 8, 16-level mold surface structures are formed. A photolithography process according to the present disclosure may provide for development of features at the ˜1 [symbol] m level in the horizontal direction. As discussed above, after the photoresist is developed by exposing it to UV light 52, the substrate (e.g. silicon wafer 44) is etched down to an expected depth. The etching may comprise reactive ion etching (RIE), which may comprise a multi-step plasma-induced process. During the RIE process, gases are first introduced into the etch chamber. For example, SF6/O2/CHF3 may be used with flow rates of 20/10/10 sccm, respectively. After these gases are broken down into chemically reactive particles by the plasma, these radicals diffuse to the surface of the substrate 44 and are absorbed by the silicon material layer. This absorption causes a reaction between the radicals and silicon, which results in reaction byproducts being diffused and cycled out of the chamber. A process according to the present disclosure may use, for example, a pressure of 20 mTorr and a substrate temperature of 5° C., with a high power of 100 W, resulting in an etch rate of about 4 nm/s. For a 2-level FZP, an etch depth of 490 nm may be used. A 4-level may use a step size of 245 nm, a 8-level may have a step size of 123 nm, and a 16-level may undergo a step size of 62 nm. After each etching step, photolithography is again used to deposit a new pattern. For example, after etching the 2-level step, photolithography may be used to apply a new pattern, and the 4-level step may be etched, and the process may continue until the desired number of levels is reached. Structures formed according to the process described herein were evaluated with a scanning electron microscope (SEM), which confirmed that errors in the 3D mold surface were within +/−5 nm.

The surfaces of the mold segments 8 may be treated to provide for release of the DOE 10 from the mold 5. For example, Atomic Layer Deposition (ALD) may be utilized to form a layer of aluminum oxide on the mold surfaces of the mold sections 8. The aluminum oxide may be, for example, approximately 5 nm thick.

During the photolithography process, a hexagon outline may be added to the silicon wafers 44 to indicate the outermost extent of the active area of each hexagon mold section 8. After the etching, cleaning, and coating of the mold sections 8 is completed, the mold sections 8 may be diced (cut) using standard processes. The cut may be, for example, about 10 microns into the active area of each mold section 8 (verified using a coordinate measuring machine after dicing). It was determined experimentally that 10 micron undersized cuts resulted in proper positioning of the hexagon mold sections 8 within the larger mold 5 formed on substrate 70 (FIG. 7). In addition to the hexagon mold sections 8 in the active area of the mold 5 corresponding to the active area of the DOE 10, an additional ring of blank hexagons may be fabricated and cut as a buffer for the polymer casting process. For example, the outer ring 8E (FIG. 7) of the hexagon mold sections may comprise blank sections without 3D mold surface features.

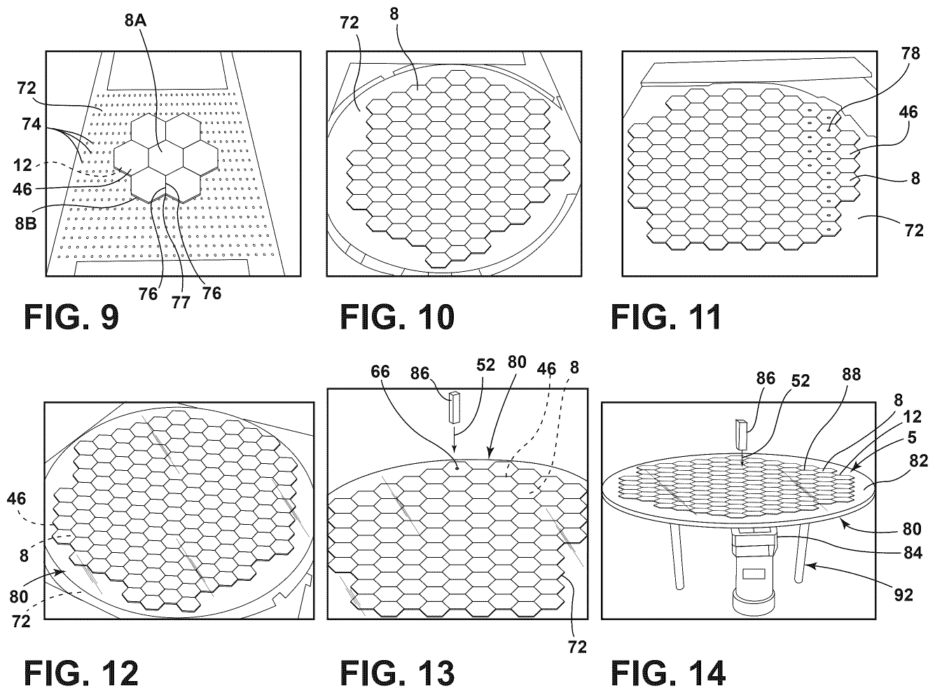

The mold assembly process is shown in FIG. 9-14. With reference to FIG. 9, the individual mold sections 8 are positioned on a flat surface 72 with the 3D mold surface features 12 facing downwardly. Surface 72 preferably comprises a flat vacuum table that is preferably flat to better than 25 microns across the active area (i.e. the area of the final mold 5 having 3D mold surface features 12) because the flatness of the assembled mold 5 depends, at least in part, on the flatness of surface 72. The use of a vacuum table having a surface 72 with a plurality of small openings 74 having suction applied thereto retains the individual mold sections 8 during the assembly process.

Referring again to FIG. 9, a center mold section 8A is initially placed on flat surface 72, and additional mold sections 8 are positioned around the center mold section 8A to form a first ring 8B. During assembly, pressure may be applied radially inwardly on mold sections 8 forming ring 8B whereby edges 76 of adjacent mold sections 8 fit closely together and abut one another at joints 77. Very small gaps may be formed along at least some portions of joints 77 due to variations in edges 76 of mold sections 8. In FIG. 9, a total of seven individual mold sections 8 are positioned on vacuum surface 72.

With reference to FIG. 10, additional mold sections 8 are then positioned on surface 72 to form additional rings about the center mold section 8A. In FIGS. 10, 82 mold sections 8 are positioned on flat surface 72. As the additional mold sections 8 are assembled in rings around the center mold section 8A, the individual mold sections 8 are positioned face down (i.e. with 3D mold surface features 12 facing vacuum surface 72), and pressure is applied to each mold section 8 radially inwardly (e.g. by hand) towards center mold section 8A. The dicing (cutting) of the individual mold sections 8 is preferably done accurately whereby each consecutive ring seats to the prior ring with little or no gap. As noted above, the perimeters of mold sections 8 may be cut undersize (e.g. 10 microns) to ensure that the assembled mold sections can be assembled with adjacent edges abutting one another.

With further reference to FIG. 11, after the required number of mold sections 8 are positioned on surface 72, adhesive 78 is applied on the back side or lower surface 46 of each mold section 8. Adhesive 78 may comprise, for example, an epoxy that may be cured upon exposure to UV light. Preferably, a precise amount (e.g. 100 ul) of the adhesive 78 is applied to surface 46, and spread across the surface 46 of each mold section 8 (e.g. using a pipette). An equal amount of adhesive 78 is preferably deposited on each surface 46 of each mold section 8, and a backing substrate 80 (FIG. 12) is then positioned on the surfaces 46 of the assembled mold sections 8. Backing substrate 80 may comprise, for example, glass. In an example, the backing substrate 80 may comprise a sheet of glass that is 0.5 inches thick, with a diameter of 36 inches. The backing substrate 80 is preferably moved straight down onto the surfaces 46 of mold sections 8 with little or no lateral motion. In general, lateral movement of backing substrate 80 may cause shifting of one or more mold sections 8. After backing substrate 80 is positioned on surfaces 46, vacuum provided by openings 74 of vacuum surface 72 pulls the backing substrate 80 towards the surfaces 46 of the mold sections 8, causing the adhesive 78 to spread. Adhesive 78 may be applied in small quantities forming individual dots (FIG. 11). Thus, application of vacuum (FIG. 12) may distribute the adhesive 78 across the surfaces 46 of mold sections 8. Adhesive 78 tends to equilibrate (spread evenly), and the process can be monitored to ensure that air gaps in and around adhesive 78 disappear (FIG. 12). Once the air gaps are removed, the vacuum is turned off to ensure that there is no residual strain on backing substrate 80.

With reference to FIG. 13, UV light 52 may be applied to a center portion 66 of each individual mold section 8 to cure a portion of adhesive 78 at a center of each mold section 8 to tack each individual mold section 8 to the backing substrate 80. UV light 52 may be applied utilizing a UV lamp 86 with a fiber optic lightguide (not shown) attached to the UV lamp 86 to ensure that the UV radiation 52 is only applied to the center of each mold section 8. In general, at this stage of the mold assembly process, UV light 52 is not applied along the joints formed by edges 76 of mold sections 8 to avoid curing adhesive 78 at joints 77, which curing could cause mold sections 8 to be adhered to vacuum surface 72.

With further reference to FIG. 14, the backing substrate 80 and mold 5 are then removed from the flat surface 72 and the backing substrate 80 and mold 5 (mold sections 8) are rotated 180° so that the mold sections 8 forming mold 5 are positioned on an upper side 82 of backing substrate 80. A UV light source 84 is then positioned under the backing substrate 80, and UV light is applied to cure the adhesive 78 to thereby fully bond the individual mold sections 8 to the backing substrate 80 to form mold 5. Backing substrate 80 may be positioned on a support 92 having an opening or transparent (erg-glass) structure that permits UV light to pass through cure adhesive 78. In general, UV light source 84 may comprise a relatively large UV lamp whereby a larger area of adhesive 78 can be cured without moving UV lamp 84. The UV light may be applied with sufficient intensity and time to harden the structure. In general, this may require several hours total, across numerous separate locations (e.g. if UV light source 84 has a horizontal dimension that is less than a horizontal dimension of mold 5). After curing the adhesive 78 with the UV light source 84 positioned below backing substrate 80, additional UV light is then applied from above mold 5. The UV light may be applied from above mold 5 utilizing a smaller UV light source 86, or the larger UV light source 84 may be utilized. Applying UV light 52 from the top side 88 of mold 5 ensures that the adhesive 78 positioned in the joints 77 between adjacent mold sections 8 is cured.

Excess adhesive 78 may then be removed from mold 5 using a combination of wiping uncured adhesive (e.g. epoxy) with an appropriate solvent (e.g. acetone) and scraping cured adhesive (epoxy) with a razor blade or other suitable tool. In this way, the entire surface 12 of the silicon mold surface 5 may be cleaned. Additional resting time may be provided to permit the adhesive 78 to fully cure before the mold 5 is used.

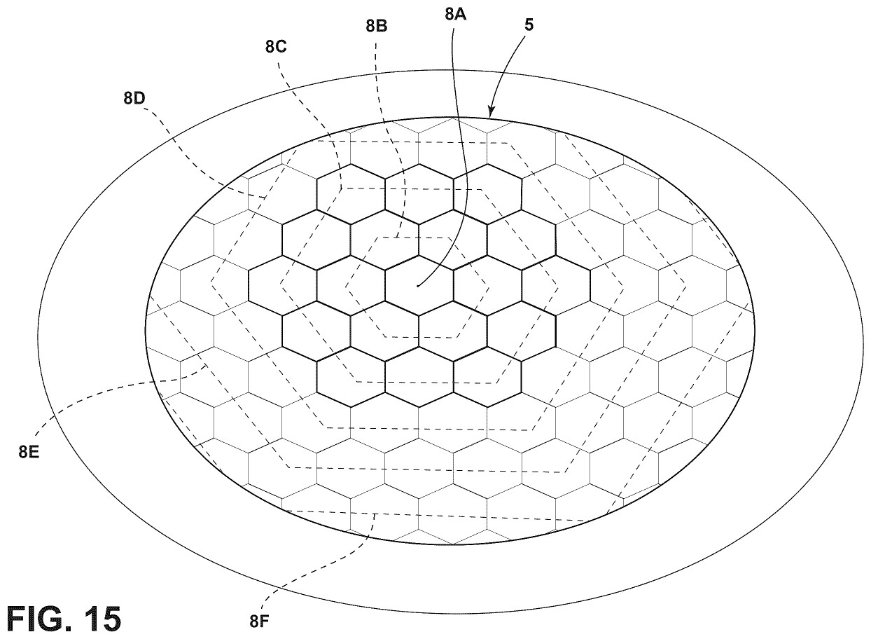

With further reference to FIG. 15, a mold 5 according to an example includes a center mold section 8A. Center mold section 8A may have 16 levels (see also FIG. 5), and the next two rings 8B and 8C may have four steps or levels. For example, the next two rings 8D and 8E may have two steps. The example of FIG. 5 includes a total of 91 hexagonal mold sections 8. As noted above, a mold 5 may optionally include one or more additional outer rings (e.g. ring 8F) that are flat, and do not include steps to form diffractive elements in a DOE 10. Mold 5 may optionally include additional sections 8 having 3D diffractive surface features to form a larger mold 5 if required. Thus, very large molds may be formed by using additional mold sections 8 as required.

With further reference to FIG. 16, after the mold 5 is assembled, uncured polymer material 6 may be positioned on surface 12 of mold 5 to form a DOE 10. Various polymers and processes may be utilized to form the DOE 10, and the following is merely an example of one suitable process. According to an example, the polymer (transfer film) suspension 6 may be cast on the mold 5 using a doctor blade or spin coater. The suspension may comprise a chemically imidized polyimide powder which may comprise a colorless polyimide suitable for long-duration, space-based applications where transparency is needed for functionality which polyimide powder may be dissolved in DMAc (N, N-dimethylacetamide (DMAc, Aldrich, HPLC grade)).

The cast polymer suspension 6 and mold 5 may be placed in a vacuum chamber 90 to eliminate air bubbles in polymer 6 prior to curing to prevent formation of structural and/or optical defects in the DOE 10. The solvent of polymer 6 may be removed using heating cycles to cure polymer 6. The heating cycles may be, for example, 50° C., 100° C., and 150° C., for about one hour at each temperature, and the heating cycles may be applied while the polymer 6 and mold 5 are in vacuum chamber 90. After the heating cycles, the mold 5 and polymer material 6 may be removed from vacuum chamber 90, and the polymer 6 may be dried slowly in ambient conditions. The thoroughly dried patterned membrane (DOE 10) is then peeled off the mold 5 (see also FIG. 1). The fabricated DOE 10 may then be soaked in a remover to eliminate any residual material on the surface of the DOE 10. The DOE 10 is then washed to slow down the drying speed to minimize film shrinkage and prevent wrinkle generation during the post drying. The drying preferably occurs slowly at room temperature. The washed (patterned) membrane (DOE 10) may then be post-dried using hydrophobic filter papers. In general, a mold 5 may be reused to form numerous DOEs 10. The mold 5 may be cleaned after it is used to form a DOE, and polymer material 6 may be deposited and cured as described above to form additional DOEs 10 using the same mold 5.

The optical performance of a cast DOE 10 fabricated according to the process described above was tested. The test DOE 10 had a 16-level center mold section 8A and six surrounding mold sections 8B that were 4-level. During testing, the 16-level center portion was found to be ˜92% efficient, and the 4-level portion was about ˜67% efficient. This implies that the whole optic (DOE 10) would be about ˜69% efficient for a continuous circle encompassing the active area of the DOE 10. Testing the DOE as a whole yielded an efficiency of 58+/−3%. The Point Spread Function (PSF) of the test DOE 10 was found to be 39+/−6 μm. In general, these results demonstrate the efficacy of the process described above and also demonstrated that additional mold sections 8 (e.g. hexagons) can continue to be added to a mold 5 to increase the area of the DOE 10 thereby making it possible to fabricate very large DOEs which may be in the form of a membrane. The combination of photolithography and dry plasma etching as described herein is suitable for developing nanostructures for optics or molds. As described herein, the same basic process may be expanded through the use of segmentation (e.g. the use of individual mold sections 8), and the segments 8 may be assembled into a functional mold 5 having a required size to produce a DOE 10 of a required size.

It will be understood that the mold sections 8 do not necessarily need to be hexagonal, and the mold sections 8 may have various shapes. Nevertheless, hexagonal mold sections 8 may be advantageous in some cases. In the example of FIG. 7, the hexagonal mold sections of a first ring 8B may all be identical. The next ring 8B may comprise only 2 unique hexagons to allow for less complex fabrication and assembly. Specifically, the mold sections 8 at locations 94 may be identical to one another, and the mold sections 8 at locations 96 may be identical to one another. As noted above, the wafer 44 may comprise silicon having polished surfaces 45 and 46. Although silicon is a suitable material, substrate 44 may comprise virtually any suitable material. Also, one or both surfaces 45 and 46 may be unpolished. Also, as discussed above, adhesive 78 may comprise an epoxy that cures when exposed to UV light. In a preferred embodiment, adhesive 78 comprises a NORLAND®optical adhesive 81 (NOA 81) available from NORLAND®products of Jamesburg, New Jersey. This epoxy is preferably utilized in connection with a silicon wafer 44 having polished upper and lower surfaces 45 and 46, respectively. It is noted that during the assembly process maintaining flatness of the mold sections 8 may be important. Thus, a vacuum table having a flat surface 72 may be utilized to ensure that the mold 5 has sufficient flatness. In general, the radial symmetry of hexagon mold sections 8 facilitates proper alignment between adjacent mold sections 8 at joints 77 (FIG. 9). If hexagon mold sections 8 are utilized, once the center hexagon mold section 8 is in place, inward pressure on the successive rings provides relatively fast alignment of the individual mold sections 8 relative to one another.

A DOE 10 produced according to the present disclosure is believed to be well suited for many applications, including applications requiring large deployable optics. A DOE 10 according to the present disclosure may be utilized in applications requiring one or several discrete wavelengths and techniques such as LIDAR, laser communication, and instrumentation (telescopes, imaging instruments) utilized I various space-based instrument applications. A membrane DOE according to the present disclosure may enable new architectures due to the flexibility of the DOE 10. If a flexible polymer is utilized, a DOE 10 according to the present disclosure can be packed and into a small compartment or space, and unpacked (deployed) for use. A DOE 10 according to the present disclosure may also have a relatively large size, when flat (deployed) minimal mass, and significantly reduced volume relative to known optical devices. A DOE 10 according to the present disclosure may be nearly weightless, thereby enabling architectures that were previously not possible, (e.g. cubesats utilized for various commercial/scientific applications).

A device according to the present disclosure may comprise a diffractive lens for LIDAR and laser communications, imaging optics for telescopes, and other imaging instruments. A device fabricated according to the present disclosure may also be utilized for vortex measurements using membranes (turbulence), or acoustic energy measurement systems that utilize very thin flexible membranes. A thin flexible membrane utilized for acoustic energy measurement systems may comprise a continuous aperture microphone phased array rather than discrete sensor arrays which have been employed for these measurements. Accelerometers and/or other displacement sensors may be attached to a membrane according to the present disclosure in a predefined pattern to measure the mode structure as the membrane is acoustically excited. Non-contact interferometric techniques may also be utilized to determine the mode structure. In general, a membrane according to the present disclosure may also be utilized to focus/collect energy (e.g. sunlight) on a lunar surface for energy or sintering/fusing regolith. A membrane according to the present disclosure may also be utilized in Filtered Rayleigh Scattering (FRS) techniques (FARSS).

The size of prior mold-based DOEs has limited to the largest wafers (e.g. 12 inches) that exist and fit into the processing equipment. In contrast, a process according to the present disclosure permits fabrication of a mold using mold segments whereby mold segments can be assembled to provide a mold having a desired size. The desired size may be as large as required for a particular application. For example, a mold and DOE according to the present disclosure may be 5 feet, 10 feet, 20 feet, 30 feet, 50 feet, or larger as required for a particular application.

Also, as discussed above, a process according to the present disclosure may be utilized to form membranes for acoustic testing and other such non-optical applications. In general, the membranes utilized for non-optical applications do not need to include diffractive elements. Thus, the mold surfaces of the mold sections 8 utilized for forming non-optical membranes may be flat, or the mold surfaces may have other surface contours or shapes as required for a particular application. Also, it will be understood that the polymer utilized to form the membrane does not necessarily need to be clear if a membrane has been fabricated for acoustic testing applications or the like. Still further the polymer 6 used to form membranes may be selected to provide increased or decreased flexibility as required for a particular application.

What is claimed is:

1. A method of forming a diffractive optical element (DOE), the method comprising:
forming a plurality of mold segments that can be closely positioned adjacent one another along edges of adjacent mold segments;
affixing the mold segments to a backing substrate adjacent one another to form a substantially continuous mold having a three-dimensional (3D) mold surface comprising an inverse of a 3D surface of a DOE to be formed by the mold segments;
depositing uncured polymer material on the 3D mold surface;
curing the polymer material to form a substantially continuous one-piece DOE having diffractive surface elements on at least one side thereof that are formed by the 3D mold surface; and:
removing the substantially continuous one-piece DOE from the 3D mold surface.

2. The method of claim 1, including:
determining a diffraction pattern of a one-piece DOE to be formed, wherein the diffraction pattern is based, at least in part, on: 1) a wavelength of light that will pass through the one-piece DOE in use, and/or: 2) a focal length of the one-piece DOE, and/or: 3) a size of the one-piece DOE, and/or: 4) a refractive index of the cured polymer material of the one-piece DOE, and/or: 5) a focusing efficiency of the one-piece DOE.

3. The method of claim 1, wherein:
each mold segment defines a perimeter;
the shapes and sizes of the perimeters are identical.

4. The method of claim 3, wherein:
the perimeters are hexagonal.

5. The method of claim 1, wherein:
each mold segment has first and second opposite sides;
and wherein the first sides include mold surfaces with 3D features that form portions of the diffractive surface elements of the substantially continuous one-piece DOE.

6. The method of claim 5, wherein:
affixing the mold segments to the backing substrate includes positioning the mold segments on the backing substrate;
the backing substrate has a flat upper surface;
the second sides of the mold segments are flat and engage the flat upper surface of the backing substrate when the mold segments are positioned on the backing substrate.

7. The method of claim 1, wherein:
the mold segments are formed from a rigid material utilizing photolithography and etching; and:
the mold segments are affixed to the backing substrate to form a pattern about a central portion of the mold surface.

8. The method of claim 7, wherein:
the pattern formed by the mold segments is radially symmetric about the central portion of the mold surface.

9. The method of claim 8, wherein:
the mold segments include 3D mold surfaces corresponding to diffractive features of the one-piece DOE;
a 3D mold surface at the central portion of the mold surface includes features of a first size;
a 3D mold surface of at least one mold segment outside of the central portion of the mold surface includes features of a second size that are smaller than the first size;
whereby at least one of the diffractive features at a central portion of the one-piece DOE has a size that is greater than a size of at least one diffractive feature formed by the at least one mold segment outside of the central portion of the mold surface.

10. The method of claim 9, wherein:
the 3D mold surface includes at least some indentations that are formed by a multi-step photolithography and etching process, whereby additional material is removed during successive steps to form deeper portions in indentations formed during prior photolithography and etching steps, and wherein a horizontal dimension of material removed during successive steps is reduced relative to a horizontal dimension of material removed during prior steps.

11. The method of claim 9, wherein:
the mold segments form at least four concentric rings about a central mold segment.

12. The method of claim 1, wherein:
the diffractive surface elements form: 1) a Fresnel Zone Plate and/or: 2) a photon sieve.

13. The method of claim 1, wherein:
the uncured polymer material comprises polyimide powder that is dissolved in solvent;
the mold segments comprises silicon wafers having first and second opposite side surfaces; and including:
forming 3D mold features corresponding to the diffractive surface elements in the first side surfaces of the silicon wafers using a multi-step chemical etching process;
after the uncured polymer material is deposited on the 3D mold surface, positioning the mold and uncured polymer material in a vacuum to remove air bubbles from the uncured polymer material; and
heating the mold and uncured polymer material while the uncured polymer is positioned in a vacuum to thereby remove solvent from the uncured polymer.

14. The method of claim 1, wherein:
the cured polymer material is flexible whereby the substantially continuous one-piece DOE comprises a flexible membrane that can be deformed and stowed in a collapsed configuration inside a fairing of a launch vehicle, followed by deploying the substantially continuous one-piece DOE into a substantially flat configuration for use in space when the substantially continuous one-piece DOE is not inside the fairing.

15. A method of forming a flexible membrane, the method comprising:
forming a plurality of mold segments, each having a mold surface, a back surface, and a perimeter, where in the perimeters of the mold segments have substantially identical shapes and sizes;
affixing the mold segments to a backing substrate adjacent to one another in rings about a center mold segment to form a mold having a substantially continuous mold surface;
depositing uncured polymer material on the mold surface;
curing the polymer material to form a substantially continuous one-piece flexible membrane; and
removing the flexible membrane from the mold surface.

16. The method of claim 15, wherein:
the perimeters of the mold segments are hexagonal.

17. The method of claim 15, wherein:
the mold segments comprise a rigid material, and the mold surface is formed utilizing photolithography and etching.

18. The method of claim 15, wherein:
the flexible membrane comprises a diffractive optical element (DOE) having three-dimensional (3D) refractive surface features;
the mold segments include 3D mold surfaces corresponding to diffractive features of the DOE.

19. A method of making a mold, the method comprising:
forming a plurality of mold segments, each having a perimeter and a mold surface comprising three-dimensional (3D) mold surface features comprising inverses of a 3D surface of a diffractive optical element (DOE) to be formed, wherein the perimeters of the mold segments are substantially identical to one another;
affixing the mold segments to a backing substrate adjacent to one another in concentric rings about a center mold segment to form a mold having a substantially continuous 3D mold surface.

20. The method of claim 19, wherein:
the mold segments comprise a rigid material, and the 3D mold surface features are formed utilizing photolithography and etching.
